(19) United States
(12) Patent Application Publication
(10) Pub. No.: US 2018/0229561 A1
(43) Pub. Date: Aug. 16, 2018

(54) METHOD FOR MOUNTING A MOTOR VEHICLE TYRE ON A RIM OF A WHEEL

(71) Applicant: Inmess GmbH, Bremen (DE)

(72) Inventors: Siegfried Schraudolf, Ganderkesee (DE); Erwin Neumann, Neustadt (DE)

(73) Assignee: Inmess GmbH, Bremen (DE)

(21) Appl. No.: 15/743,014

(22) PCT Filed: Jun. 17, 2016
(86) PCT No.: PCT/EP2016/001021

§ 371 Date: Jan. 9, 2018

(30) Foreign Application Priority Data
Jul. 23, 2015 (DE) 10 2015 009 335.5

(51) Int. Cl. B60C 25/05; B60C 25/132; B60C 25/14

(52) U.S. Cl. CPC B60C 25/0515; B60C 25/0548; B60C 25/0596; B60C 25/142; B60C 25/0521; B60C 25/132

(57) ABSTRACT

A method, device, and installation for mounting a motor vehicle tire on a rim of a wheel, characterized in that at least one tire bead of the motor vehicle tire is prestretched in a targeted manner before the tire is pulled onto the rim, in particular before the tire beads are pulled over the rim flanges of the rim.

The invention relates to a method for mounting a motor vehicle tire on a rim of a wheel. The invention further relates to a device which can be used within the context of the mounting method and to a tire-mounting installation having a pulling-on station for the, in particular automatic, pulling of a motor vehicle tire onto a rim of a wheel.

Mounting methods and mounting installations for mounting a motor vehicle tire on a rim of a wheel are known in the prior art. They comprise, in particular, the so-called pulling of the tire onto the associated rim of the wheel. High forces or torques are necessary here to pull the tire beads over the rim flanges of the rim. This applies both to essentially manual and to automatic pulling-on methods. It is possible here for there to occur damage to the beads or twisting thereof.

Taking this as the starting point, it is an object of the present invention to further develop the mounting method mentioned at the outset and to specify a device by means of which the further-developed mounting method can be implemented. It is also an object of the invention to specify a tire-mounting installation in which the further-developed method can be applied.

This object is achieved by a mounting method having the features of claim 1, a device having the features of claim 14 and a tire-mounting installation having the features of claim 15.

Accordingly, there is provision according to the invention for at least one tire bead to be prestretched in a targeted manner before the tire is pulled onto the rim of the wheel (apart from a rim, a wheel has a so-called disk), in particular before the tire beads are pulled over the rim flanges of the rim within the context of the actual pulling-on operation. As a result, it is possible, inter alia, for the subsequent pulling of the tire onto the rim to be facilitated. In addition, it has been shown that prestretching the tire beads contributes to reducing twisting of the beads or bead cores and/or to reducing bead damage.

Accordingly, before pulling the respective tire onto the respective rim, stretching forces are introduced into the at least one tire bead in a targeted manner. Here, dependent on the exact configuration of the subsequent pulling-on operation, it can be sufficient according to the invention to prestretch only one of the two tire beads of a tire. However, it may also be expedient to prestretch both tire beads, either simultaneously or in succession.

To implement the method according to the invention, it is possible, for example, to provide tensioning means which are moved in particular by motor or by a corresponding motor-operatored drive and which bear in a distributed manner over a circle circumference on the inside of the at least one or the respective tire bead and, in order to stretch the respective tire bead, are in particular uniformly radially outwardly displaced and in this manner introduce forces into the respective tire bead.

According to the invention, the prestretching process can occur on a separate prestretching device or a separate prestretching machine before—for example in a tire-mounting workshop—the tires are in each case pulled onto the rim either by hand using mounting tools or partly or fully automatically in a tire-pulling-on machine.

Preferably however, the prestretching process will be integrated into a fully automatic tire-mounting process. In particular, automobile manufacturers and complete-wheel suppliers have at their disposal fully automatic tire-mounting installations so as to be able to originally equip the motor vehicles produced by them. In this case, the prestretching process would automatically occur upstream of a process which progresses in a tire-pulling-on station known per se and in which the respective tire is pulled automatically onto the respective rim. For this purpose, a dedicated prestretching station can preferably be integrated into the tire-mounting installation upstream of the tire-pulling-on station and the correspondingly prestretched tire can be automatically fed to the pulling-on station after prestretching. In principle, however, it is also conceivable to integrate the prestretching process directly into the pulling-on machine, and, in this case too, it would, of course, take place upstream of the pulling-on process from a process engineering standpoint.

The prestretching of the two tire beads preferably takes place simultaneously. For this purpose, the two tire beads can bear, for example, simultaneously against the aforementioned tensioning means. However, it is also conceivable for the prestretching process to be designed such that at first the first tire bead is prestretched and the second tire bead is prestretched only later or subsequently. Thus, it is conceivable for instance to design the tensioning means in such a way that in each case only one tire bead can bear against the tensioning means, with the result that the second tire bead can be prestretched only after the first tire bead has been prestretched. A wide variety of embodiments are conceivable here.

In a further design of the invention, there can be provision that the respective tire bead is prestretched in that it is stretched from an (in particular unstretched) starting diameter to a target diameter and is held for the duration of a certain holding time, in particular for at least 300 ms (milliseconds), preferably for at least 500 ms, at this target diameter.

In the further course of events, there can be provision that, after expiry of this holding time, the respective tire bead is brought back again to its starting diameter, in particular by the stretching forces being reduced continuously, stepwise or abruptly.

In the concrete implementation of this process, each of the aforementioned tensioning means could, while taking along the externally bearing tire bead, at first be moved radially outward starting from a starting position assigned thereto, in which no or only small stretching forces are introduced into the tire bead, up to a respectively assigned radial end position. In the respective radial end position, each tensioning means could remain for the duration of the holding time and correspondingly fix the maximum widened tire bead at that point. After expiry of the holding time, each tensioning means could be moved back radially inward in the opposite direction into an assigned position in which in turn no stretching forces or in any case relatively small stretching forces are introduced into the tire bead, in particular into the respective starting position. Here, the tensioning means are preferably moved uniformly radially inward and/or radially outward.

The advancing speed at which the tensioning means are moved radially outward is preferably constant at least over a certain time period.

The advancing speed can be chosen such that a widening speed is set which lies between 20 mm/min and 800 mm/min, preferably between 100 mm/min and 400 mm/min.

Moreover, it is particularly advantageous to check/to monitor and/or to control the stretching process in terms of important parameters.

Thus, provision is preferably made for the stretching forces which are introduced into the respective tire bead for prestretching the latter to be measured (directly or indirectly) during the stretching process. This can take place, for example, by means of force gages or other force-measuring devices. If, for example, the introduced stretching forces exceed predetermined limit values stored for instance in the controller, the stretching process can then be assessed as faulty. Where appropriate, there can then be provision for the corresponding tire to be discharged (automatically) from the process.

Alternatively or in addition, the current bead diameter of the respective tire bead of the tire to be stretched can also be measured during the stretching process. What is meant by bead diameter here is the inside diameter of the respective bead or bead ring in its extent perpendicular to the axis of rotation or longitudinal center axis of the tire. In the nonstretched state, this corresponds approximately to the rim diameter of a rim, which is suitable for the tire, in the bead seat of this rim. Here, in the unstretched state, the bead diameter is as a rule somewhat smaller than the bead seat diameter of the rim so as to generate, in the mounted state of the tire, sufficient clamping forces which hold the tire or the tire bead in each case in the bead seat.

Generally speaking, the values measured during the stretching process, such as, for instance, the introduced stretching forces and/or the bead diameter which is in each case currently measured during the stretching process, are preferably compared, in particular automatically, with stored desired or limit values. Should the comparison result in one or more of the measured values being situated above a (stored) limit value, a corresponding signal is generated.

In terms of control technology, there could also be provision to predetermine, for example, a desired value for a maximum bead diameter and to introduce stretching forces until the predetermined desired value has been reached. The process could then be stopped.

The measured values of the bead diameter and/or of the stretching forces are preferably stored in an electronic data memory. They can subsequently serve for documentation in order to be able to demonstrate that certain predetermined or limit values have not been exceeded during the stretching operation.

Further features of the invention will emerge from the appended patent claims, the following description of a preferred exemplary embodiment of the invention and from the appended drawing, in which:

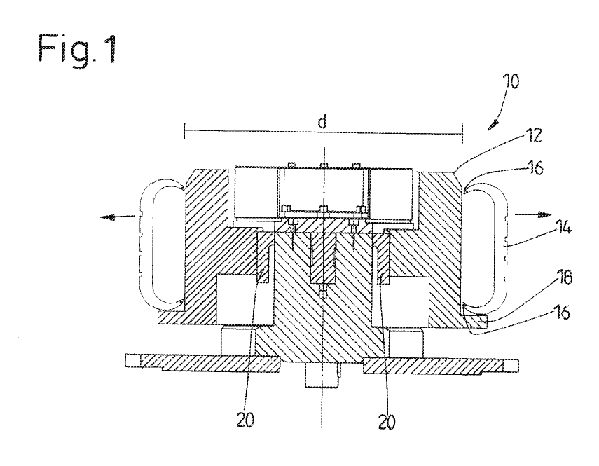

FIG. 1 shows an embodiment of a device according to the invention for prestretching tire beads (in cross section) with a tire which can be prestretched thereby.

FIG. 1 schematically shows a device 10 by means of which tire beads of motor vehicle tires can be prestretched in the manner according to the invention before they are pulled onto a suitable rim in a manner known per se.

For this purpose, the device 10 has tensioning means 12 designed as tensioning jaws which are arranged in a distributed manner over a circle circumference and which can in each case be moved by means of a motor drive (not shown) from a radially further inwardly arranged starting position in a radially further outward direction so as in so doing to prestretch a tire 14, or to be more precise the two tire beads 16 of the tire 14, bearing against the radial outer sides of the tensioning means 12.

In a manner which has not been illustrated, a central cone of the device 10, which bears against complementary inclined inner surfaces of the tensioning means 12, moves in a vertical direction and—depending on whether it is displaced upward or downward—thereby moves the tensioning jaws or tensioning means 12 bearing against it in each case horizontally radially further inward or radially further outward.

In a starting position of the tensioning means 12, tensioning means 12 arranged oppositely along the circle circumference are arranged at a distance from one another such that the tire 14 can be placed conveniently from above over the tensioning means 12. In this starting position, no or at best small stretching forces are transmitted to the tire beads 16, with the result that the tire 14 or the tire beads 16 is/are correspondingly unstretched or only slightly stretched. The tire bead diameter d shown in FIG. 1 corresponds in the normal state, that is to say in the unstretched state, approximately to the rim diameter in the bead seat of a rim suitable for the tire 14 or of a suitable rim of a wheel composed of such a rim and a corresponding disk.

Lower stop surfaces 18 of the device 10 ensure that the tire 14 remains in its position shown in FIG. 1 and cannot slip further downward.

In order to prestretch the tire beads 16, the tensioning means 12 are in each case moved radially outward (arrow directions) from their respective starting position. Here, they guide the tire beads 16 radially outward with them and in this manner introduce stretching forces into the tire beads 16.

The bead diameter d correspondingly increases here.

There is provision that the tire beads 16 are stretched in a controlled and uniform manner in the course of the prestretching until the tensioning means 12 each adopt a certain end position.

In this end position of the respective tensioning means 12, the tire 14 or the tire beads 16 is/are held for a certain holding time t, for example 300 ms or more, in order to optimize the stretching operation with a view to subsequently pulling the tire 14 onto the suitable rim.

The tensioning means 12 are then moved back again uniformly from the corresponding end position into their respective starting position. On account of the elasticity of the tires 14, the tire beads 16 draw together again independently until they are situated again in their starting state. In this state, the tires 14 can be lifted again from the device 10. This is because the starting positions of the tensioning means 12 are chosen such that, in these positions, in each case no or at best only a slight stretching of the tire beads 16 occurs and thus the tire is seated on the machine 10 or bears against the tensioning means 12 only with a small degree of tension or entirely without tension.

Force-measuring means 20, for example force gages, are used to determine the forces which are in each case currently introduced during widening of the tire beads 16. In addition, it is conceivable for the current values of the bead diameter d to be measured. The measurements can be carried out continuously, periodically or at certain time intervals.

For documentation, the measured values are stored in an electronic memory, with them each being assigned an identifier of the tire 14 on which measurements have been carried out, such as, for instance, a clear identification number thereof.

Furthermore, the measured values are each checked as to whether they are within permissible ranges or within permissible tolerances. For example, they can be compared with an (upper) limit value. Should, for example, the magnitude of the introduced forces or the bead diameter d reach or exceed a predetermined limit value at a certain time, this would be recognized as a fault and a signal would be generated.

As a result, the relevant tire 14 could be classified as a reject or defective tire 14 and separated out.

The device 10 preferably operates fully automatically after placing the respective tire 14. In other words, the tensioning means 12 are moved automatically outward into the end position, held there for the predetermined holding time t, and then moved fully automatically again in the opposite direction into a position in which no or only small forces of the beads 16 are exerted on the tensioning means 12, in particular into the starting position.

Moreover, the device 10 can be used as a stand-alone device, for example in workshops, so that it can carry out prestretching prior to subsequent pulling of the tires onto the rim by the respective workshop employee (if appropriate with the aid of a mounting machine or mounting tools).

However, the device 10 can also be part of an automatic tire-mounting installation, which generally also has, apart from a soaping station for soaping the beads 16, a pulling-on station for pulling the tires onto the respective rim. The process can be designed in such a way that the soaping, the prestretching, the mounting and, where appropriate, the subsequent air-filling of the tires then pulled onto the rim take place fully automatically.

Finally, there can also be provision that the device 10 has a suitable sensor system for quality monitoring of the tires. In particular, the values measured using the force-measuring means 20 can be evaluated in terms of quality criteria.

### LIST OF REFERENCE SIGNS

10 Prestretching machine
12 Tensioning means
14 Tire
16 Tire beads
18 Stop surface
20 Force-measuring means

1. A method for mounting a motor vehicle tire (14) on a rim of a wheel, comprising prestretching at least one tire bead (16) of the motor vehicle tire (14) in a targeted manner before the tire (14) is pulled onto the rim, in particular before the at least one tire bead (16) is pulled over the rim flanges of the rim.

2. The method as claimed in claim 1, wherein stretching forces which are introduced into the at least one tire bead (16) for prestretching the at least one tire bead are measured during the stretching process.

3. The method as claimed in claim 2, wherein the at least one tire bead has a bead diameter, and further comprising measuring the bead diameter of the at least one tire bead (16) during the stretching process.

4. The method as claimed in claim 3, further comprising comparing the measured values with stored desired or limit values.

5. The method as claimed in claim 3, further comprising storing the measured values in an, in particular electronic, data memory.

6. The method as claimed in claim 1, wherein the at least one tire bead (16) is prestretched in that the at least one tire bead (16) is stretched from a starting diameter to a target diameter and held for a predetermined holding time, in particular at least 300 ms, preferably at least 500 ms, at this target diameter.

7. The method as claimed in claim 6, further comprising, after expiry of the holding time, bringing the at least one tire bead (16) back again to the starting diameter, in particular by the stretching forces being reduced continuously, stepwise or abruptly.

8. The method as claimed in claim 1, wherein the at least one tire bead (16) is prestretched in that tensioning means (12), in particular tensioning jaws, which bear in a distributed manner over a circle circumference on the inside of the tire bead (16), are preferably uniformly radially further outwardly displaced and in so doing stretch the tire bead (16) by introducing stretching forces.

9. The method as claimed in claim 8, further comprising moving the tensioning means (12), in each case after reaching a radial end position with maximum widening of the at least one tire bead (16), back into respective starting positions with no or relatively small widening of the tire bead (16), in particular into starting positions in which no or correspondingly relatively small stretching forces are introduced into the tire bead (16).

10. The method as claimed in claim 8, wherein the tensioning means (12) are moved radially further outward at an advancing speed chosen such that a widening speed is set which lies between 20 mm/min and 800 mm/min, preferably between 100 mm/min and 400 mm/min.

11. The method as claimed in claim 8, wherein the at least one tire bead (16) of the tire (14) is at first automatically prestretched by the tensioning means (12), and in that, after prestretching the at least one tire bead (16), the tire is pulled automatically onto the rim.

12. The method as claimed in claim 11, wherein the tensioning means (12) are part of a prestretching station for prestretching the at least one tire bead (16) of a tire-mounting installation, wherein the tire-mounting installation has, downstream of the prestretching station, a pulling-on station for automatically pulling the tire (14) onto the rim.

13. The method as claimed in claim 12, wherein, after its at least one tire bead (16) has been stretched, the respective tire (14) is fed automatically to a pulling-on device, in particular of the pulling-on station of the tire-mounting installation in claim 12 in which the tire is pulled onto the rim.

14. A device for mounting a motor vehicle tire (14) on a rim of a wheel, the device comprising, in particular motor-movable, tensioning means for the targeted prestretching of at least one tire bead (16) of a motor vehicle tire (14) before the tire (14) is pulled onto a rim of a wheel, in particular before the tire beads (16) are pulled over the rim flanges of the rim.

15. A tire-mounting installation having a pulling-on station for the, in particular automatic, pulling of a motor vehicle tire onto a rim of a wheel, wherein the tire-mounting installation preferably has motor-movable tensioning means for the targeted prestretching of at least one tire bead (16) before pulling the motor vehicle tire onto the rim.

16. The tire-mounting installation as claimed in claim 15, wherein the tensioning means (12) for prestretching the at least one tire bead (16) are part of a prestretching device for prestretching tire beads (16) that is arranged upstream of the pulling-on station in the process sequence, the prestretching device comprising, in particular motor-movable, tensioning means for the targeted prestretching of at least one tire bead (16) of a motor vehicle tire (14) before the tire (14) is pulled onto a rim of a wheel, in particular before the tire beads (16) are pulled over the rim flanges of the rim.

17. The tire-mounting installation as claimed in claim 16, for mounting a motor vehicle tire (14) on a rim of a wheel, comprising prestretching at least one tire bead (16) of the motor vehicle tire (14) in a targeted manner before the tire (14) is pulled onto the rim, in particular before the at least one tire bead (16) is pulled over the rim flanges of the rim.
